(19) United States
(12) Patent Application Publication
(10) Pub. No.: US 2012/0007505 A1
(43) Pub. Date: Jan. 12, 2012

(54) LIGHT SOURCE UNIT OF SEMICONDUCTOR-TYPE LIGHT SOURCE OF VEHICLE LIGHTING DEVICE AND VEHICLE LIGHTING DEVICE

(75) Inventors: Masateru HAYASHI, Isehara-shi (JP); Katsuaki Nakano, Isehara-shi (JP)

(73) Assignee: ICHIKOH INDUSTRIES, LTD.

(21) Appl. No.: 13/179,962

(22) Filed: Jul. 11, 2011

(30) Foreign Application Priority Data
Jul. 12, 2010 (JP) 2010-157778

(51) Int. Cl. B60Q 1/14; H05B 37/02

(52) U.S. Cl. 315/77; 315/294

(57) ABSTRACT

To reliably provide a wiring element for feeding power to a light emitting chip so as not to be shorted. The present invention provides: a board 3; light emitting chips 40 to 44; resistors R1 to R12 and diodes D1 and D2, each of which serves as a control element; and conductors 51 to 57, wire lines 61 to 65, and bonding portions 610 to 650, each of which serves as a wiring element. A first conductor 51 is mounted on either one side of a mount surface 34 of the board 3 that is divided into two sections by means of a line segment L connecting the light emitting chips 41, 42 and 43, 44. As a result, the present invention is capable of reliably providing the first conductor 51 and a third wire line 63 for feeding power to the light emitting chips 40 to 44 so as not to be shorted.

### CROSS REFERENCE TO RELATED APPLICATIONS

This application claims priority of Japanese Patent Application No. 2010-157778 filed on Jul. 12, 2010. The contents of this application are incorporated herein by reference in their entirety.

### BACKGROUND OF THE INVENTION

1. Field of the Invention

The present invention relates to a light source unit of a semiconductor-type light source of a vehicle lighting device. In addition, the present invention relates to a vehicle lighting device using a semiconductor-type light source as a light source.

2. Description of the Related Art

A light source unit of such a type is conventionally known (for example, Japanese Unexamined Patent Application Publication No. 2-205080, Japanese Unexamined Patent Application Publication No. 2007-176219, or Japanese Unexamined Patent Application Publication No. 2009-21264). Hereinafter, such a conventional light source unit will be explained. The light source unit of Japanese Unexamined Patent Application Publication No. 2-205080 is constructed so that: an LED bear chip is mounted on a board (a lead frame) and a resistor is connected to constitute a light emitting portion; and this light emitting portion is incorporated in a holder and a base metal. The light source unit of Japanese Unexamined Patent Application Publication No. 2007-176219 is constructed so that: a plurality of LED chips are mounted on a board; a reflector is disposed on the board; and top faces of the LED chips are covered with a resin. The light source unit of Japanese Unexamined Patent Application Publication No. 2009-21264 is constructed so that: a plurality of LED chips are provided on a main face of a board (a base portion) via a plurality of insulation heat sinks; the plurality of LED chips are sealed with a resin mold; a support member and a plurality of heat radiation fins are provided on a back face of the board; and a base metal is provided on the support member.

In such light source units, it is an essential problem to be solved by the invention to reliably provide a wining element for feeding power to an LED bear chip (an LED chip) so as not to be shorted.

The problems to be solved by the invention are: to reliably provide a wiring element for feeding power to an LED bear chip (an LED chip) so as not to be shorted; to reduce a wire disconnection stress (a wire disconnection load) of a wire as the wiring element; and to reduce a stress (a load) of a bonding portion of the wiring element.

### SUMMARY OF THE INVENTION

A first aspect of the present invention is characterized in that: A light source unit of a semiconductor-type light source of a vehicle lighting device, comprising:

a mount member;

a plurality of light emitting chips of semiconductor-type light sources that are intensively mounted on the mount member;

a control element that is mounted on the mount member, for controlling light emission of the light emitting chips; and

wiring elements that are mounted on the mount member, for feeding power to the light emitting chips via the control element,

wherein the plurality of the light emitting chips are divided into two groups,

the light emitting chips in a first group is sandwiched between the light emitting chips in a second group, and

among the wiring elements, a wiring element for feeding power to the light emitting chip in the first light emitting chips is mounted on either one side of mounting surface of the mount member that is divided into two sections by means of a line segment connecting the light emitting chips in the second group configured to sandwich the light emitting chips in the first group.

A second aspect of the present invention is characterized in that the light source unit of the semiconductor-type light source of the vehicle lighting device, according to first aspect,

wherein the plurality of the light emitting chips are disposed at a center part of the mounting surface of the mount member, and

the control element is disposed at a peripheral portion of the mounting surface of the mount member.

A third aspect of the present invention is characterized in that: the light source unit of the semiconductor-type light source of the vehicle lighting device, according to first aspect,

wherein the light emitting chips in the first group are light emitting chips to which a low current is to be supplied,

the light emitting chips in the second group are light emitting chips to which a mass current is to be supplied,

the control element for controlling light emission of the light emitting chips in the second group comprises at least a diode, and

a pull-down resistor for detecting a wire disconnection of the light emitting chips in the second group is disposed at a rear stage of the diode.

A fourth aspect of the present invention is characterized in that, the light source unit of the semiconductor-type light source of the vehicle lighting device, according to first aspect,

wherein the light emitting chips in the first group are light emitting chips to which a low current is to be supplied,

the light emitting chips in the second group are light emitting chips to which a mass current is to be supplied,

the control element for controlling light emission of the light emitting chips in the second group comprises at least a resistor, and

the resistor is disposed so as to be positioned in a location that is upper than a position of the plurality of the light emitting chips when the light source unit is mounted on the vehicle lighting device.

A fifth aspect of the present invention is characterized in that the light source unit of the semiconductor-type light source of the vehicle lighting device, according to first aspect,

wherein a part of the wiring elements is comprised of wire lines that are respectively electrically connected to the plurality of the light emitting chips, and

the plurality of the wire lines are provided in parallel to each other or in substantially parallel to each other.

A sixth aspect of the present invention is characterized in that: a vehicle lighting device using a semiconductor-type light source as a light source, comprising:

a lamp housing and a lamp lens that partition a lamp room; and

a light source unit of a semiconductor-type light source of the vehicle lighting device according to any one of the first aspect to the fifth aspect that is disposed in the lamp room.

A light source unit of a semiconductor-type light source of a vehicle lighting device, according to a first aspect of the present invention, does not need to provide a wiring element for feeding power to light emitting chips in a second group by means for solving the above-described problems, the wiring element (for example, a wire line or a gold wire) being capable of mutually approaching neighboring wiring elements (for example, conductors, patterns, or conductor patterns), the wiring element being configured to electrically interconnect the neighboring wiring elements (for example, conductors, patterns, or conductor patterns), so as to be bridged over the wiring elements (for example, conductors, patterns, or conductor patterns) for feeding power to light emitting chips in a first group to thus able to eliminate a failure that the wiring element (for example, a wire line or a gold wire) for feeding power to the light emitting chips in the second group comes into contact with the wiring elements (for example, conductors, patterns, or conductor patterns) for feeding power to the light emitting chips in the first group and then is shorted (short-circuited). In this manner, the light source unit of the semiconductor-type light source of the vehicle lighting device according to the first aspect of the present invention is capable of reliably wiring the wiring element for feeding power to light emitting chips so as not to be shorted.

Moreover, the light source unit of the semiconductor-type light source of the vehicle lighting device, according to the first aspect of the present invention, is provided in such a manner that the wiring element for feeding power to the light emitting chips in the second group, the wiring element (for example, a wire line or a gold wire) being configured to electrically interconnect the neighboring wiring elements (for example, conductors, patterns, or conductor patterns) can be reduced in length to able to reduce failures caused by its large length, i.e., failures such as cutting of a wiring element (for example, a wire line or a gold wire) during charging a sealing member or in expansion or contraction of members such as a cured sealing member or removing a connecting portion (a bonding portion) of the wiring element (for example, a wire line or a gold wire). That is, the light source unit of the semiconductor-type light source of the vehicle lighting device according to the first aspect of the present invention is capable of reducing the length of the wiring elements (for example, a wire line or a gold wire) to thus able to reduce a wire disconnection stress of the wiring element (for example, a wire line or a gold wire) or able to reduce a stress (a load) of the connecting portion (the bonding portion) of the wiring element (for example, a wire lines or a gold wire). In this manner, the light source unit of the semiconductor-type light source of the vehicle lighting device according to the first aspect of the present invention is capable of reliably providing the wiring element for feeding power to the light emitting chips.

Still moreover, the light source unit of the semiconductor-type light source of the vehicle lighting device, according to the first aspect of the present invention, is provided in such a manner that the wiring element for feeding power to the light emitting chips in the second group, the wiring element being capable of mutually approaching the neighboring wiring elements (for example, conductors, patterns, or conductor patterns), can thus increase an area of the neighboring elements (for example, conductors, patterns, or conductor patterns), and can thus effectively radiate a heat that is generated in the neighboring wiring elements (for example, conductors, patterns, or conductor patterns) to the outside, accordingly. That is, a heat radiation effect is improved.

In addition, a light source unit of a semiconductor-type light source of a vehicle lighting device, according to a second aspect of the present invention, is provided in such a manner that a plurality of light emitting chips are disposed at a center part on a mounting surface of a mount member, and a control element is disposed at a peripheral part of the mounting surface of the mount member (that is, outside of the plurality of light emitting chips) to thereby able to increase an area of wiring elements (for example, conductors, patterns, or conductor patterns) for feeding power to the plurality of light emitting chips. As a result, the light source unit of the semiconductor-type light source of the vehicle lighting device according to the second aspect of the present invention can effectively radiate to the outside a heat that is generated in the wiring elements (for example, conductors, patterns, or conductor patterns) for feeding power to the plurality of light emitting chips. That is, a heat radiation effect is improved.

Further, a light source unit of a semiconductor-type light source of a vehicle lighting device, according to a third aspect of the present invention, is provided in such a manner that a pull-down resistor for detecting a wire disconnection of light emitting chips in a second group is disposed at a rear stage of a diode as a control element for controlling light emission of the light emitting chips in the second group, whereby in the pull-down resistor, an inversion polar surge can be eliminated at a diode at a front stage, so that a capacitive durability quantity considering only a forward directional surge will suffice. As a result, the light source unit of the semiconductor-type light source of the vehicle lighting device according to the third aspect of the present invention can downsize the pull-down resistor to thereby able to increase an area of wiring elements (for example, conductors, patterns, or conductor patterns) for feeding a mass current to the light emitting chips in the second group. In this manner, the light source unit of the semiconductor-type light source of the vehicle lighting device according to the third aspect of the present invention can effectively radiate to the outside a heat that is generated in the wiring elements (for example, conductors, patterns, or conductor patterns) for feeding the mass current to the light emitting chips in the second group. That is, a heat radiation effect is improved.

Furthermore, a light source unit of a semiconductor-type light source of a vehicle lighting device, according to a fourth aspect of the present invention, is provided in a such a manner that when the light source unit is mounted on the vehicle lighting device, a resistor as a control element for controlling light emission of light emitting chips in a second group to which a mass current is to be supplied is positioned in a location that is upper than that of a plurality of light emitting chips, and thus, a heat that is generated in the resistor is released upward without having an effect on the plurality of light emitting chips. That is, durability and performance or the like of the plurality of light emitting chips can be improved by utilizing a property of upward heat releasing.

Still furthermore, a light source unit of a semiconductor-type light source of a vehicle lighting device, according to a fifth aspect of the present invention, is provided in such a manner that a plurality of wire lines that are electrically connected respectively to a plurality of light emitting chips are wires in parallel to each other or in a substantially parallel to each other so that: wiring workability of the plurality of wire lines is improved; a production speed increases; and manufacturing costs can be reduced. Moreover, the plurality of wire lines are coincident with each other in a unidirectional manner or in a substantially unidirectional manner, so that electrical reliability of the plurality of wire lines is improved.

Yet furthermore, a vehicle lighting device according to a sixth aspect of the present invention can achieve an advantageous effect that is similar to that of the light emitting unit of the semiconductor-type light source of the vehicle lighting device according to any one of the first to fifth aspects, by means for solving the above-described problems.

### BRIEF DESCRIPTION OF THE DRAWINGS

FIG. 1 is an explanatory view showing an exemplary embodiment of a light source unit of a semiconductor-type light source of a vehicle lighting device according to the present invention and showing a disposition state of light emitting chips, a control element, a wiring element, and a connecting member that are mounted on a mount member, and is a plan view of the mount member.

FIG. 2 is a partially enlarged plan view showing a part of the light emitting chips and the wiring element, similarly.

FIG. 3 is a partially enlarged plan view showing a part of light emitting chips and the wiring element in a state in which wire lines are bridged over conductors.

FIG. 4 is a plan view showing a first conductor, similarly.

FIG. 5 is a plan view showing a second conductor, similarly.

FIG. 6 is a plan view showing a third conductor, similarly.

FIG. 7 is a plan view showing a fourth conductor, similarly.

FIG. 8 is a plan view showing a fifth conductor, similarly.

FIG. 9 is a plan view showing a sixth conductor, similarly.

FIG. 10 is a plan view showing a seventh conductor, similarly.

FIG. 11 is an electrical circuit diagram depicting a drive circuit of the semiconductor-type light source of the light source unit, similarly.

FIG. 12 is an exploded perspective view of a light source portion of the light source unit and an insulation member, a heat radiation member, and a power feeding member of a socket portion, similarly.

FIG. 13 is an exploded perspective view of the light source unit and the socket portion, similarly.

FIG. 14 is a perspective view showing a state in which the light source portion and the socket portion are assembled with each other, similarly.

FIG. 15 is a plan view of a state in which the light source portion, the socket portion, and the connecting member are assembled with each other, similarly.

FIG. 16 is a longitudinal sectional view (a vertical sectional view) showing a state in which the light source unit is assembled with the vehicle lighting device, similarly, i.e., a longitudinal sectional view (a vertical sectional view) showing an exemplary embodiment of the vehicle lighting device according to the present invention.

FIG. 17 is an explanatory view showing a modification example of wire lines.

FIG. 18 (A) to FIG. 18 (F) are explanatory views, each of which shows a modification example of disposition of a plurality of light emitting chips.

### DESCRIPTION OF THE PREFERRED EMBODIMENTS

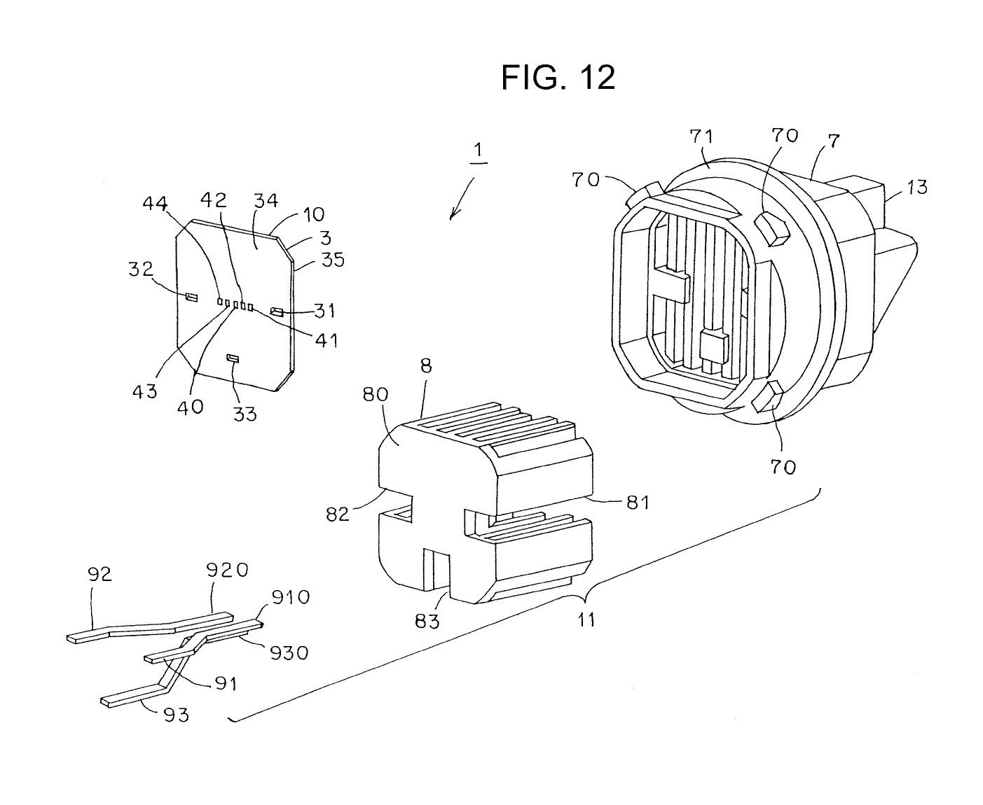

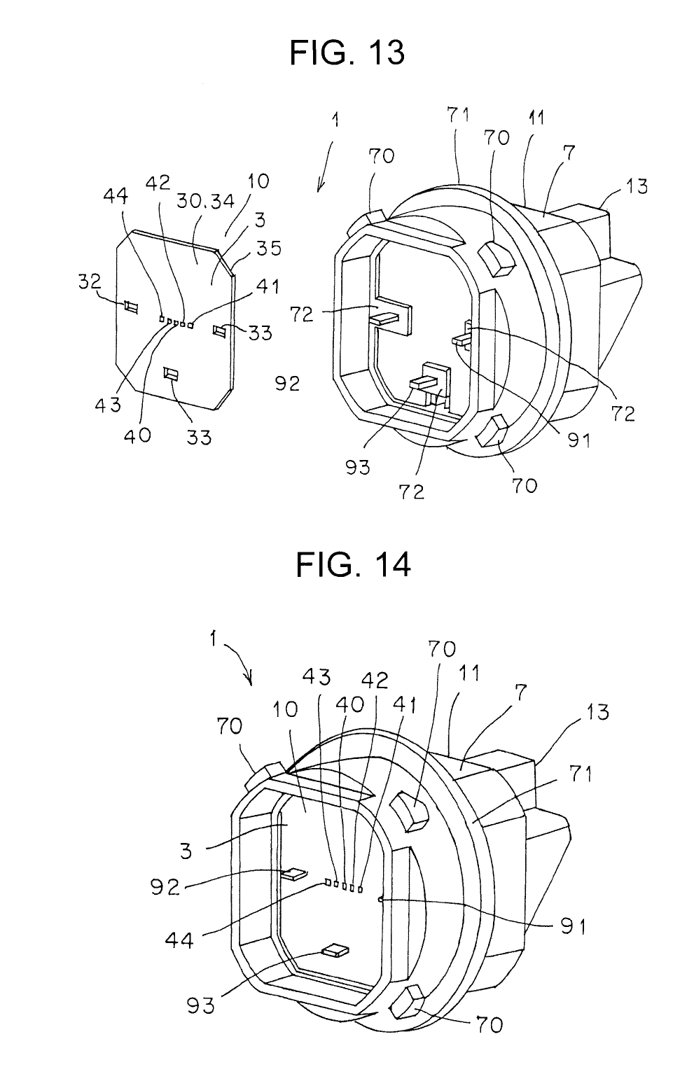

Hereinafter, with reference to the drawings, a detailed description will be given with respect to an exemplary embodiment of a light source unit of a semiconductor-type light source of a vehicle lighting device according to the present invention and an exemplary embodiment of the vehicle lighting device according to the present invention. It should be noted that the present invention is not limited by the exemplary embodiments. In FIG. 12 to FIG. 15, a control element and a wiring element are not shown. In addition, in FIG. 12 to FIG. 14, a connecting member is not shown.

### Exemplary Embodiments

(Description of Configuration)

Hereinafter, a description will be given with respect to a configuration of a light source unit of a semiconductor-type light source of a vehicle lighting device, in the exemplary embodiment, and the vehicle lighting device in the exemplary embodiment. In FIG. 26, reference numeral 100 designates the vehicle lighting device in the exemplary embodiment.

(Description of Vehicle Lighting Device 100)

The vehicle lighting device 100 is a single-lamp type tail/stop lamp in this example. That is, the vehicle lighting device 100 uses a tail lamp function and a stop lamp function in one combination by means of a single lamp (one lamp or one lighting device). The vehicle lighting device 100 is provided in a respective one of the left and right at a rear part of a vehicle (not shown). The vehicle lighting device 100 may be combined with another lamp function (for example, a backup lamp function or a turn signal lamp function), although not shown, to thereby constitute a rear combination lamp.

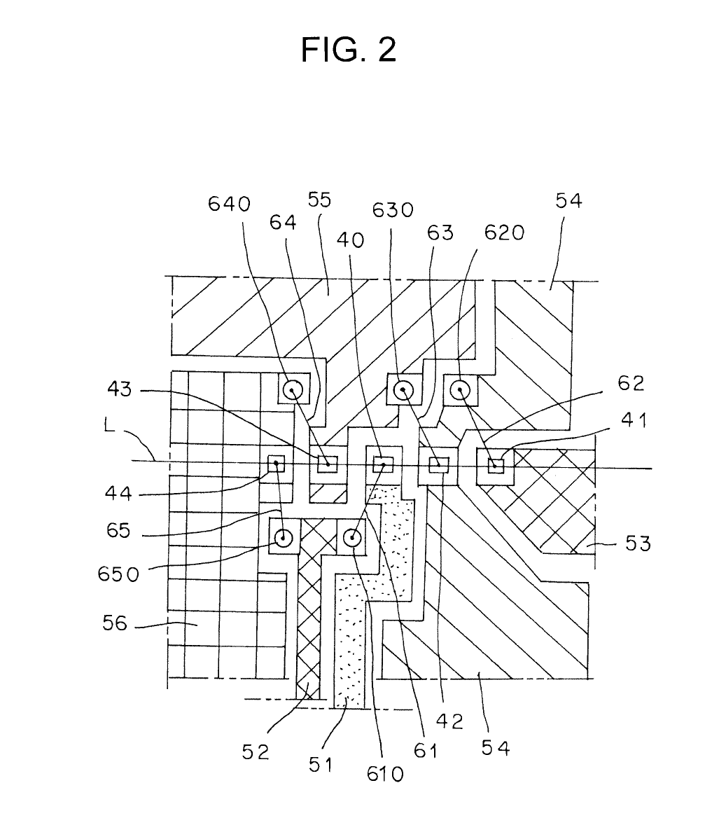

The vehicle lighting device 100, as shown in FIG. 2, is provided with: a lamp housing 101, a lamp lens 102; a reflector 103; a light source unit using a semiconductor-type light source as a light source, i.e., a light source unit 1 of the semiconductor-type light source of the vehicle lighting device, in the exemplary embodiment; and a drive circuit (not shown) of the semiconductor-type light source of the light source unit 1.

The lamp housing 101 is comprised of an optically opaque member, for example (a resin member, for example). The lamp housing 101 is formed in a hollow shape that opens at one side and that is closed at the other side. A through hole 104 is provided in a closed portion of the lamp housing 101.

The lamp lens 102 is comprised of an optically transmissible member, for example (a transparent resin member or a glass member, for example). The lamp lens 102 is formed in a hollow shape that opens at one side and that is closed at the other side. A circumferential edge part of an opening portion of the lamp lens 102 and a circumferential edge part of an opening portion of the lamp housing 101 are fixed to each other with water tightness. A lamp room 105 is partitioned by means of the lamp housing 101 and the lamp lens 102.

The reflector 103 is a light distribution control portion that controls optical distribution of light that is radiated from the light source unit 1, and has a focal point F. The reflector 103 is disposed in the lamp room 105 and is fixed to the lamp housing 101 or the like. The reflector 103 is comprised of an optically opaque member, for example (a resin member or a metal member, for example). The reflector 103 is formed in a hollow shape that opens at one side and that is closed at the other side. In a closed portion of the reflector 103, a through hole 106 is provided so as to communicate with the through hole 104 of the lamp housing 101. A reflection surface 107 is provided on an internal face of the reflector 103. Although the reflector 103 is made of a member that is independent of the lamp housing 101, this reflector may be integrated with the lamp housing. In this case, a reflector function is provided while a reflection surface is provided in a part of the lamp housing. The through hole 104 of the lamp housing 101 is formed in a circular shape. At an edge of the through hole 104, a plurality of recessed portions (not shown) and a plurality of stopper portions (not shown) are provided at substantially equal intervals.

(Description of Light Source Unit 1)

The light source unit 1, as shown in FIG. 12 to FIG. 16, is provided with a light source portion 10, a socket portion 11, a cover portion 12, and a connecting member 17. The light source portion 10 and the cover portion 12 are mounted at one end part (an upper end part) of the socket portion 11. The light source portion 10 is covered with the cover portion 12.

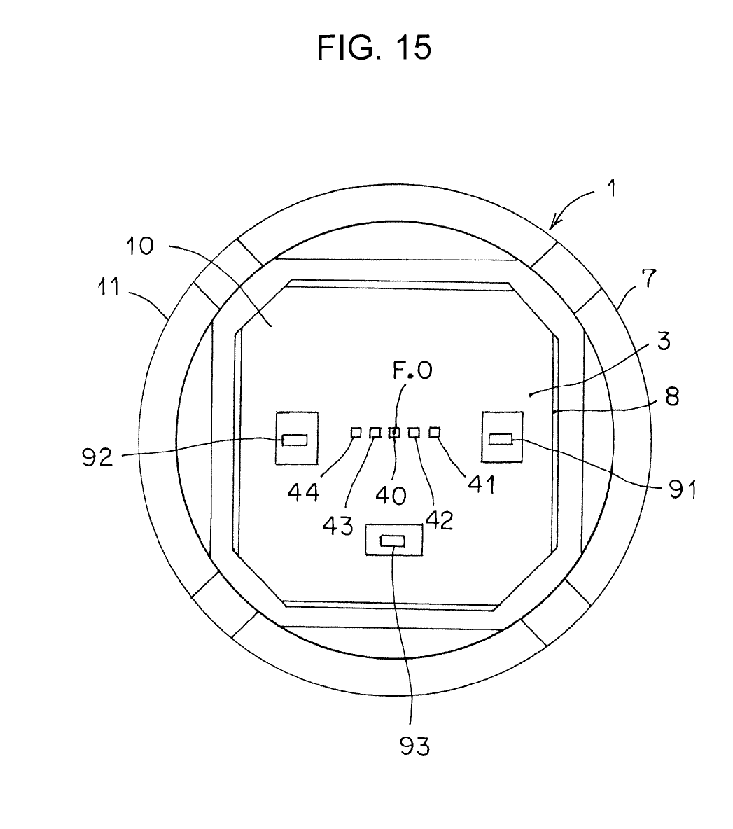

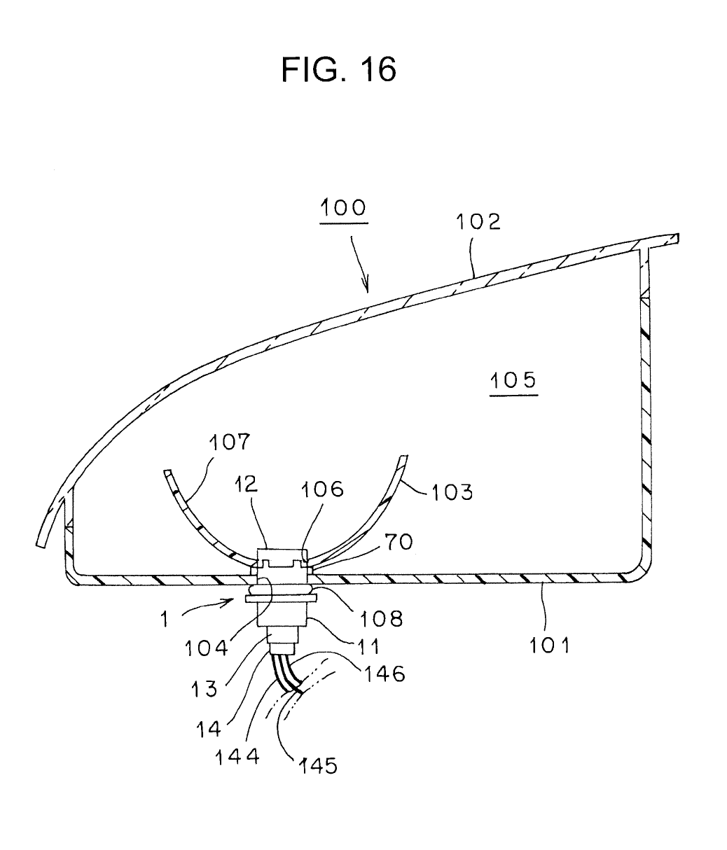

The light source unit 1, as shown in FIG. 16, is mounted on the vehicle lighting device 100. That is, the socket portion 11 is removably mounted on the lamp housing 101 via a packing (an O-ring) 108. The light source portion 10 and the cover portion 12 are disposed in the lamp room 105 through the through hole 104 of the lamp housing 101 and the trough hole 106 of the reflector 103, and are disposed on the side of the reflection surface 107 of the reflector 103.

(Description of Light Source Portion 10)

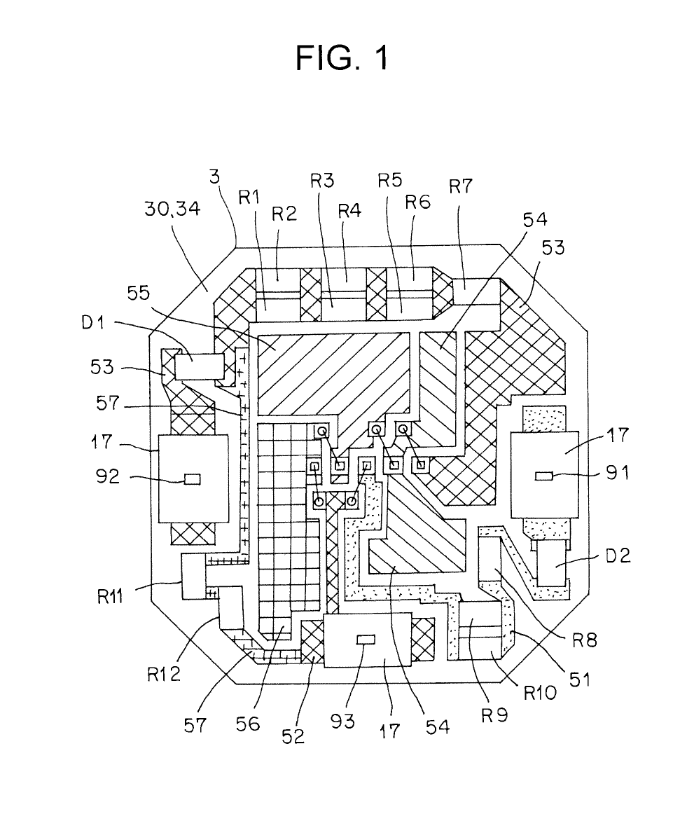

The light source portion 10, as shown in FIG. 1 to FIG. 3 and FIG. 12 to FIG. 15, is provided with: a board 3 that serves as a mount member; a plurality of, in this example, five light emitting chips 40, 41, 42, 43, and 44 of the semiconductor-type light source; resistors R1 to R12 and diodes D1 and D2, each of which serves as a control element; and conductors (patterns or conductor patterns) 51 to 57, wire lines (gold wires) 61 to 65, and bonding portions 610 to 650, each of which serves as a wiring element.

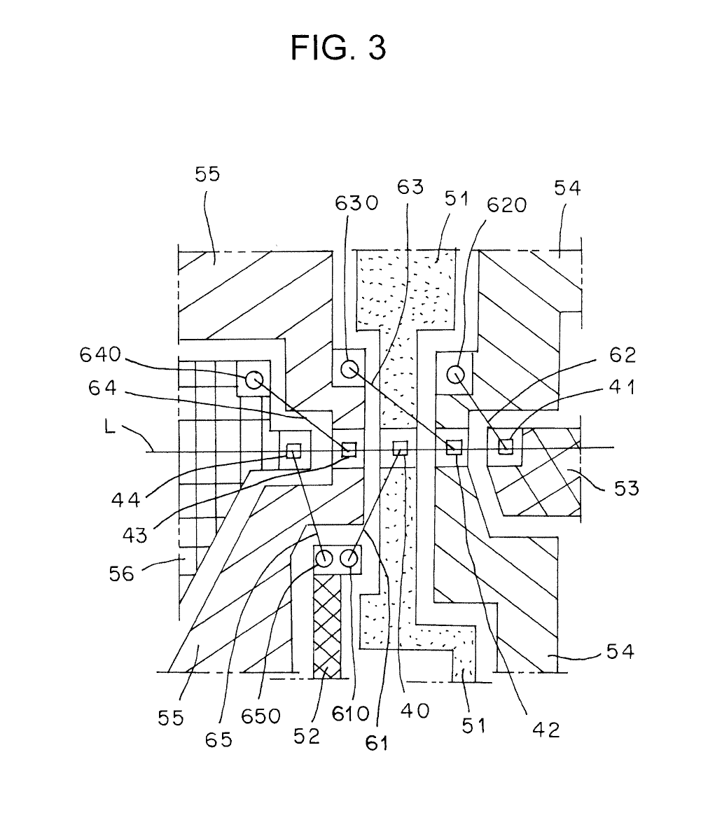

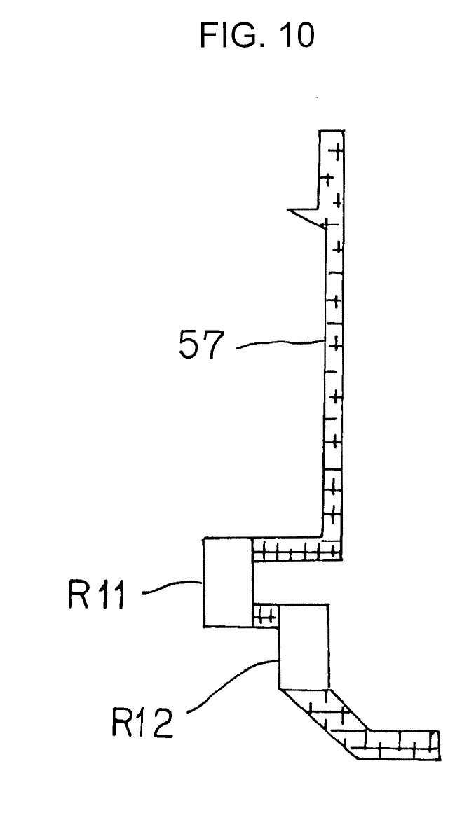

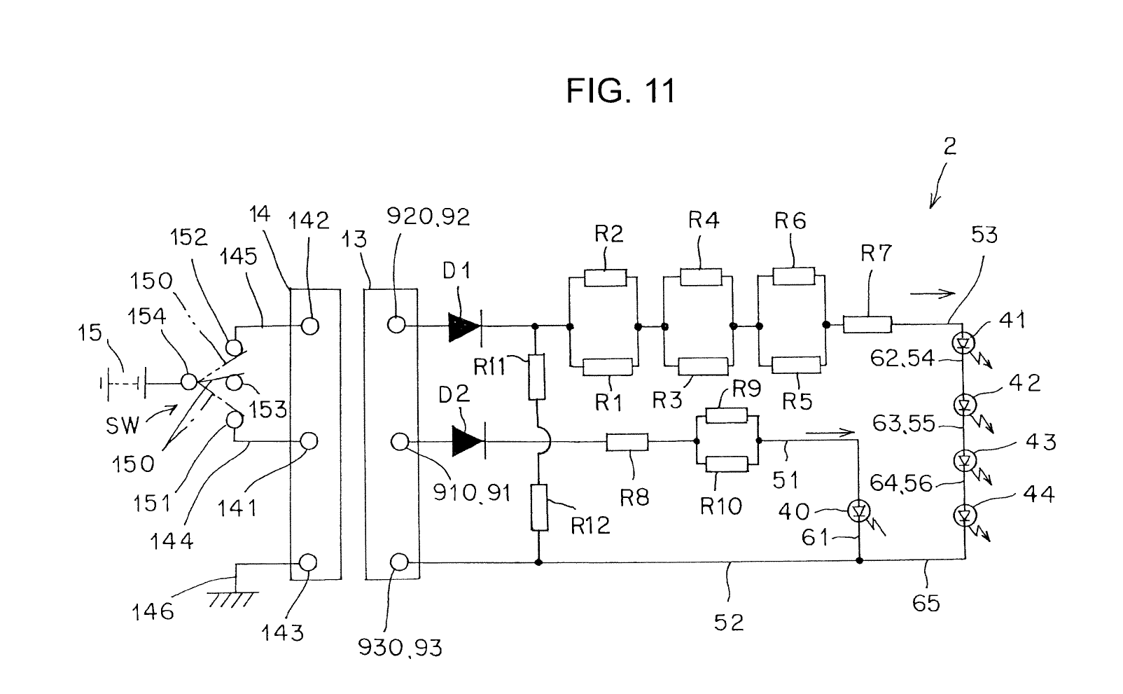

The board 3 is made of ceramics in this example. The board 3, as shown in FIG. 1, FIG. 3 to FIG. 6, FIG. 10, and FIG. 11, is formed in a substantially octagonal plate shape as seen from a plan (top) view. Through holes 31, 32, and 33 through which power feeding members 91, 92, and 93 of the socket portion 11 are to be inserted are respectively provided at substantial centers of three edges (a right edge, a left edge, and a lower edge) of the board 3. A flat mounting surface 34 serving as a mounting surface is provided on one face (a top face) of the board 3. A flat abutment surface 35 is provided on the other face (a bottom face) of the board 3. A high reflection surface 30 subjected to high reflection coating or high reflection vapor deposition or the like may be further provided on the mounting surface 34 of the board 3 made of ceramics that is a high reflection member.

The mounting surface 34 of the board 3 is configured to mount the five light emitting chips 40 to 44, the resistors R1 to R12, the diodes D1 and D2, the conductors 51 to 57, the wire lines 61 to 65, the bonding portion 610 to 650, and the connecting member 17 thereon (that is, these elements are provided by means of a process such as mounting, printing, burning, or vapor deposition). Although not shown, a part of the five light emitting chips 40 to 44 and the wiring elements that are mounted on the mounting surface 34 of the board 3 (a part of the conductors 51 to 57, the wire lines 61 to 65, and the bonding portions 610 to 650) is sealed with a sealing member comprised of an optically transmissible member, for example, an epoxy resin, via a bank member. Alternatively, a whole of the mounting surface 34 of the board 3 (such as the five light emitting chips 40 to 44, the control elements, and the wiring elements) are sealed with a sealing member.

The semiconductor-type light source made of the five light emitting chips 40 to 44 uses a spontaneous optical semiconductor-type light source (an LED in this exemplary embodiment) such as an LED or an EL (an organic EL). The light emitting chips 40 to 44, as shown in FIG. 1, FIG. 2, and FIG. 12 to FIG. 15, are made of microscopic rectangular (square or rectangle-shaped) semiconductor chips (light source chips) as seen from a plan (top) view, and are made of bear chips in this example. The five light emitting chips 40 to 44 radiate light from a front face and a side face other than a surface that is mounted on the board 3. The five light emitting chips 40 to 44, as shown in FIG. 15, are disposed so as to be substantially similar to light emission caused by arc discharge from a filament of a light source bulb or an electric discharge bulb (an HID lamp) at a focal point F of the reflector 103 of an optical system and in one array in proximity of a center (a mount rotation center) O of the socket portion 11 of the light source 1. In addition, the five light emitting chips 40 to 44 are disposed at a center part of the board 3.

The five light emitting chips 40 to 44 are light emitting chips to which a low current is to be supplied, and are divided into one light emitting chip 40 serving as a light source of a tail lamp, i.e., the light emitting chip 40 in a first group, and light emitting chips to which a mass current is to be supplied, four light emitting chips 41 to 44 serving as light sources of a stop lamp, i.e., the light emitting chips 41 to 44 in a second group. One light emitting chip 40 having the tail lamp function (the light source of the tail lamp) is disposed in a state it is sandwiched between the two light emitting chips 41 and 42 having the stop lamp function (the light sources of the stop lamp) at the right side and the two light emitting chips 43 and 44 having the stop lamp function (the light sources of the stop lamp) at the left side. The four light emitting chips 41 to 44 having the stop lamp function are connected in series in a forward direction.

The resistors R1 to R12 are made of thin-film resistors or thick-film resistors, for example. The resistors R1 to R10 are adjustment resistors for obtaining a predetermined value of a drive current. That is, the value of the drive current that is to be supplied to the light emitting chips 40 to 44 varies depending on a distortion of Vf (voltage characteristics in forward direction) of the light emitting chips 40 to 44, and a distortion occurs in brightness (luminous flux, luminance, luminous intensity, or intensity of illumination) of the light emitting chips 40 to 44. Thus, a value of the resistors R1 to R9 is adjusted (trimmed) and then the value of the drive current that is to be supplied to the light emitting chips 40 to 44 are set to be substantially constant at a predetermined value, whereby a distortion of the brightness (luminous flux, luminance, luminous intensity, or intensity of illumination) of the light emitting chips 40 to 44 can be adjusted (absorbed). Alternatively, while brightness (luminous flux, luminance, luminous intensity, or intensity of illumination) of the light emitting chips 40 to 44 is directly monitored, the value of the resistors can be trimmed and adjusted so that the brightness (luminous flux, luminance, luminous intensity, or intensity of illumination) of the light emitting chips 40 to 44 becomes constant. The trimming is cutting part or all of the resistors R1 to R9 by means of laser beams, for example, and then, adjusting an (open) resistor value. The resistor value is increased by means of opening and tripping.

The resistors R11 and R12 are pull-down resistors for detecting a wire disconnection of the four light emitting chips 41 to 44 in the second group, which serves as light sources of the stop lamp. The resistors R11 and E12 are connected in series between a rear stage (a cathode side) of the diode D1 having the stop lamp function and the power feeding member 93 on a ground side.

In FIG. 10, although there are respectively disposed: the three resistors R8 to R10 that are connected in series to one light emitting chip 40 having the tail lamp function; the seven resistors R1 to R9 that are connected in series to the four light emitting chips 41 to 44 having the stop lamp function; and the two resistors R11 and R12 that are connected in series to a rear stage of the diode D1 having the stop lamp function, the number of dispositions may be varied depending on a resistor capacity and a variable width of a resistor to be adjusted. That is, the number of the resistors is not limited.

The diodes D1 and D2 are made of diodes such as bear chip diodes or SMD diodes, for example. The diode D2 that is connected in series to one light emitting chip 40 having the tail lamp function and the resistors R8 to R10 and the diode D1 that is connected in series to the four light emitting chips 41 to 44 having the stop lamp function and the resistors R1 to R7 are diodes of an incorrect connection preventing function and a pulse noise protecting function from an opposite direction.

The resistors R1 to R12 and the diodes D1 and D2, each of which serves as the control element, are disposed at a peripheral part of the board 3. That is, the resistors R1 to R12 and the diodes D1 and D2, each of which serves as the control element, are disposed outside of the five light emitting chips 40 to 44.

The conductors 51 to 57 are made of wires such as thin-film wires or thick-film wires of an electrically conductive member, for example. The conductors 51 to 56, the wire lines 61 to 65, and the bonding portions 610 to 650, each of which serves as a wiring element, are electrically fed to the light emitting chips 40 to 44 via the resistors R1 to R10 and the diodes D1 and D2, each of which serves as a control element.

(Description of Layout of Light Emitting Chips 40 to 44, Resistors R1 to R12, Diodes D1 and D2, Conductors 51 to 57, Wire Lines 61 to 65, and Bonding Portions 610 to 650, and Description of Drive Circuit 2)

The five light emitting chips 40 to 44; the twelve resistors R1 to R12; the two diodes D1 and D2; the conductors 51 to 57; the wire lines 61 to 65; and the bonding portions 610 to 650 are disposed and connected to each other as shown in a layout view of electric components of FIG. 10, a partially enlarged layout view of FIG. 11, and an electric circuit diagram of FIG. 11.

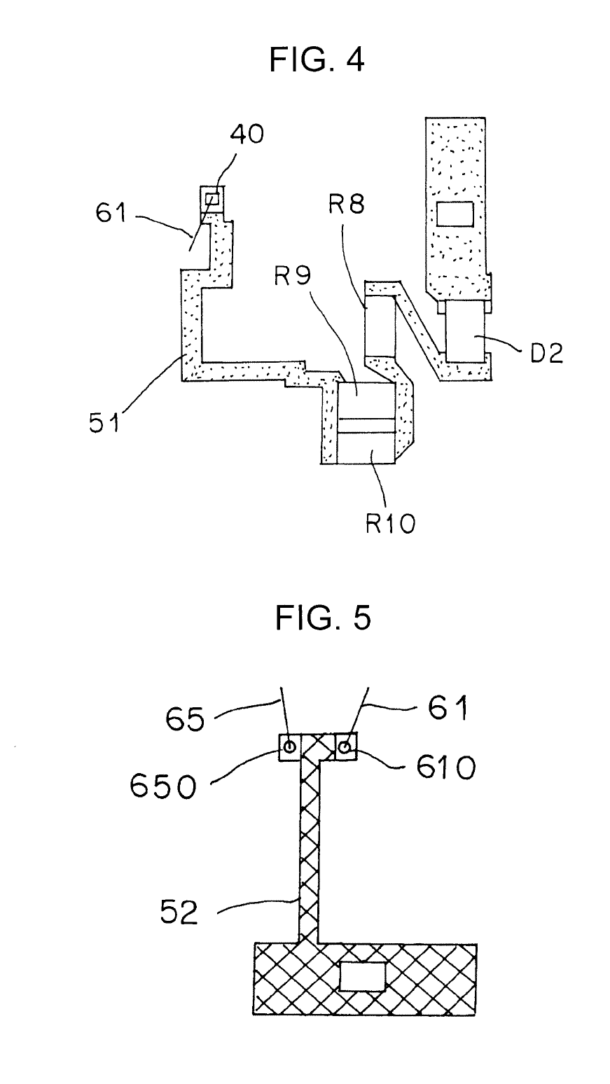

As shown in FIG. 4, a light emitting chip 40 having the tail lamp function, an eighth resistor R8, a ninth resistor R9, a tenth resistor R10, and a second diode D2 are disposed and connected in series to a first conductor 51 of a thin-film pattern or a thick-film pattern. As the resistors, the ninth resistor R9 and the tenth resistor R10 are connected in parallel to each other.

As shown in FIG. 5, a first bonding portion 610 and a fifth bonding portion 650 are disposed at a second conductor 52 of a thin-film pattern or a thick-film pattern. A first wire line 61 is connected in series to the light emitting chip 40 having the tail lamp function of the first conductor 51 and the first bonding portion 610 of the second conductor 52.

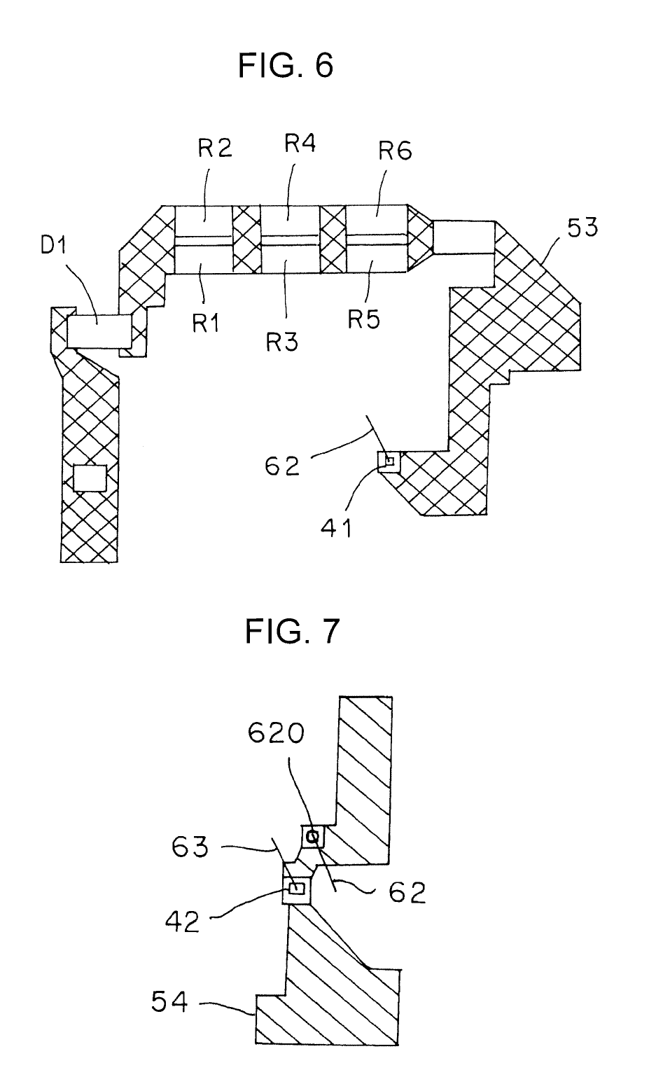

As shown in FIG. 6, a first light emitting chip 41 having the stop lamp function, resistors R1 to R7, and a first diode D1 are disposed and connected in series to a third conductor 53 of a thin-film pattern or a thick-film pattern. As the resistors, the first resistor R1 and the second resistor R2, the third resistor R3 and the fourth resistor R4, and the fifth resistor R5 and the sixth resistor R6 are respectively connected in series.

As shown in FIG. 7, a second bonding portion 620 and a second light emitting chip 42 having the stop lamp function are disposed and connected in series to a fourth conductor 54 of a thin-film pattern and a thick-film pattern. A second wire line 62 is connected in series to the first light emitting chip 41 of the third conductor 53 and the second bonding portion 620 of the fourth conductor 54.

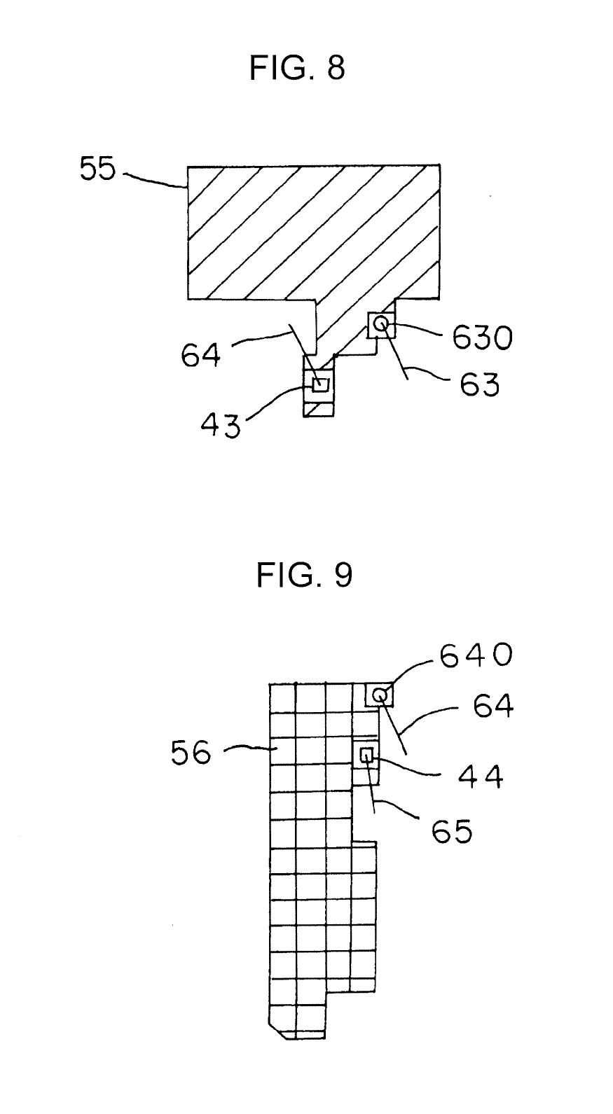

As shown in FIG. 8, a third bonding portion 630 and a third light emitting chip 43 having the stop lamp function are disposed and connected in series to a fifth conductor 55 of a thin-film pattern or a thick-film pattern. A third wire line 63 is connected in series to the second light emitting chip 42 of the fourth conductor 54 and the third bonding portion 630 of the fifth conductor 55.

As shown in FIG. 9, a fourth bonding portion 640 and a fourth light emitting chip 44 having the stop lamp function are disposed and connected in series to a sixth conductor 56 of a thin-film pattern or a thick-film pattern. A fourth wire line 64 is connected in series to the third light emitting chip 43 of the fifth conductor 55 and the fourth bonding portion 640 of the sixth conductor 56.

A fifth wire line 65 is connected in series to the fourth light emitting chip 44 of the sixth conductor 56 and the fifth bonding portion 650 of the second conductor 52.

As shown in FIG. 10, the eleventh resistor R11 and the twelfth resistor R12 are disposed and connected in series to a seventh conductor 57 of a thin-film pattern or a thick-film pattern. The seventh conductor 57 is connected to a rear stage (cathode) side of the first diode D1 of the third conductor 53 and the second conductor 52.

The light source portion 10, as described previously, is provided with: the board 3 serving as a mount member; the light emitting chips 40 to 44 of a semiconductor-type light source; the resistors R1 to R12 and the diodes D1 and D2, each of which serves as a control element; and the conductors 51 to 57, the wire lines 61 to 65, and the bonding portions 610 to 650, each of which serves as a wiring element.

The five light emitting chips 40 to 44; the ten resistors R1 to R10; the two diodes D1 and D2; the sixth conductors 51 to 56; the fine wire lines 61 to 65; and the five bonding portions 610 to 650 are divided (incorporated or grouped) by the tail lamp function and the stop lamp function.

That is, the five light emitting chips are divided into: one light emitting chip 40 having the tail lamp function to which a low current is to be supplied and of which heat generation quantity is small; and four light emitting chips 41 to 44 having the stop lamp function to which a mass current is to be supplied and of which heat generation quantity is large. The sixth conductors are divided into: the first conductor 51 for supplying a low current to one light emitting chip 40 having the tail lamp function to which the low current is to be supplied; and the third conductor 53, the fourth conductor 54, the fifth conductor 55, and the sixth conductor 56 for supplying a mass current to the four light emitting chips 41 to 44 having the stop lamp function to which the mass current is to be supplied.

The conductors 52 to 55 for the four light emitting chips 41 to 44 having the stop lamp function to which the mass current is to be supplied are divided into four sections. The first conductor 51 for the light emitting chip 40 having the tail lamp function to which the low current is to be supplied is disposed in a state in which the conductor is sandwiched between the side of the second conductor 52 and the third conductor 53 and the side of the fourth conductor 54 and the fifth conductor 55 from among the conductors for the light emitting chips 41 to 44 having the stop lamp function to which the mass current is to be supplied and divided into four sections.

In addition, as shown in FIG. 2, the first conductor 51 for the light emitting chip 40 in a first group having the tail lamp function to which the low current is to be supplied is mounted (disposed) on the mounting surface 34, i.e., either one side (a upper side in this example) of the mounting surface 34 of the board 3 that is divided into two sections (two upper and lower sides in this example) by means of a line segment (a straight line in this example) L connecting the fourth light emitting chips 41 to 44 in a second group having the stop lamp function to which the mass current is to be supplied, these chips sandwiching the light emitting chip 40 having the tail lamp function to which the low current is to be supplied.

A heat generation capacity in each of the four light emitting chips 41 to 44 having the stop lamp function to which the mass current is to be supplied; the resistors R1 to R7; the diode D1, and the conductors 53 to 56 is greater in comparison with that in each of one light emitting chip 40 having the tail lamp function to which the low current is to be supplied; the resistors R8 and R9; the diode D2; and the conductor 51.

In addition, as shown in FIG. 1, the resistors R1 to R7, each of which has a large heat generation capacity having the stop lamp function to which the mass current is to be supplied, are disposed so as to be positioned in a location that is upper than that of the five light emitting chips 40 to 44 when the light source unit 1 is mounted on the vehicle lighting device 100 (refer to FIG. 16). This is because a heat generated in the resistors R1 to R7 can be released upward without affecting the five light emitting chips 40 to 44 by utilizing a property of upward heat releasing.

Among the five light emitting chips 40 to 44, one light emitting chip 40 having the tail lamp function is disposed at a center O of the board 3 and at or near a center O of a heat radiation member 8 to be described later.

(Description of Socket Portion 11)

The socket portion 11, as shown in FIG. 12 to FIG. 16, is provided with an insulation member 7, a heat radiation member 8, and three power feeding members 91, 92, and 93. The heat radiation member 8 having its thermal conductivity and electrical conductivity and the power feeding members 91 to 93 having their electrical conductivities are integrally incorporated in the insulation member 7 having its insulation property in a state in which they are insulated from each other.

The socket portion 11 is made of an integrated structure with the insulation member 7, the heat radiation member 8, and the power feeding members 91 to 93. For example, the insulation member 7, the heat radiation member 8, and the power feeding members 91 to 93 are structured to be integrally constructed by means of insert molding (integral molding). Alternatively, the insulation member 7 and the power feeding members 91 to 93 are integrally constructed by means of insert molding (integral molding), and the heat radiation member 8 is structured to be integrally mounted on the insulation member 7 and the power feeding members 91 to 93. Alternatively, the power feeding members 91 to 93 are integrally assembled with the insulation member 7, and the heat radiation member 8 is structured to be integrally mounted on the insulation member 7 and the power feeding members 91 to 93.

(Description of Insulation Member 7)

At the insulation member 7, a mount portion is provided for removably or fixedly mounting the light source unit 1 on the vehicle lighting device 100. The insulation member 7 is made of an insulation resin member, for example. The insulation member 7 is formed in a substantially cylindrical shape whose outer diameter is slightly smaller than an inner diameter of the through hole 104 of the lamp housing 101. A jaw portion 71 is integrally provided at one end part (an upper end part) of the insulation member 7. At one end part (the upper end part) of the insulation member 7, a plurality of, in this example, four mount portions 70 are integrally provided to be associated with the recessed portion of the lamp housing 101. It should be noted that only three of the mount portions 70 are shown in FIG. 3 to FIG. 5.

The mount portion 70 is intended to mount the light source unit 1 on the vehicle lighting device 100. That is, a part on the side of the cover 12 of the socket portion 11 and the mount portion 70 are inserted into the through hole 104 and the recessed portion of the lamp housing 101. In this state, the socket portion 11 is rotated axially around the center O, and the mount portion 70 is abutted against the stopper portion of the lamp housing 101. At this time point, the mount portion 70 and the jaw portion 71 sandwiches from top and bottom an edge part of the through hole 104 of the lamp housing 101 via the packing 108 (refer to FIG. 2).

As a result, the socket portion 11 of the light source unit 1, as shown in FIG. 16, is removably mounted via the packing 108 on the lamp housing 101 of the vehicle lighting device 100. At this time point, as shown in FIG. 16, a portion that is protrusive from the lamp housing 101 to the outside, of the socket portion 11, (a portion that is lower than the lamp housing 101 in FIG. 16), is greater in size than a portion that is housed in the lamp room 105, of the socket portion 11 (a portion that is upper than the lamp housing 101 in FIG. 16).

At the other end part (a lower end part) of the insulation member 7, a connector portion 13 on a light source side is integrally provided. On the connector portion 13, a connector 14 on a power supply side is mounted mechanically, removably, and electrically.

(Description of Heat Radiation Member 8)

The heat radiation member 8 is intended to radiate the heat that is generated at the light source portion 10 to the outside. The heat radiation member 8 is made of an aluminum die cast or a resin member having its thermal conductivity (also having its electrical conductivity). The heat radiation member 8 is formed in a flat shape at one end part (an upper end part) and is formed in a fin-like shape from its intermediate part to the other end part (a lower end part). An abutment surface 80 is provided on a top face of one end part of the heat radiation member 8. The abutment surface 35 of the board 3 is mutually abutted against the abutment surface 80 of the heat radiation member 8, and in that state, these abutment surfaces are adhesively bonded with each other by means of a thermally conductive medium (not shown). As a result, the light emitting chips 40 to 44 each are positioned to be associated with a portion at which a proximal portion of the center O of the heat radiation member 8 (the center O of the socket portion 11) is positioned via the board 3.

The thermally conductive medium is a thermally conductive adhesive agent, and is made of an adhesive agent such as an epoxy-based resin adhesive agent, a silicone-based resin adhesive agent, or an acryl-based resin adhesive agent, and is made of that of a type such as a liquid-like type, a fluid-like type, or a tape-like type. The thermally conductive medium may be a kind of thermally conductive grease in addition to the thermally conductive adhesive agent.

At a substantial center of each of three edges (a right edge, a left edge, and a lower edge) of the heat radiation member 8, cutouts 81, 82, and 83 are respectively provided to be associated with the through holes 31 to 33 of the board 3. The three power feeding members 91 to 93 are respectively disposed in the cutouts 81 to 83 of the heat radiation member 8 and the through holes 31 to 33 of the board 3. The insulation member 7 is interposed between the heat radiation member 8 and each of the power feeding members 91 to 93. The heat radiation member 8 comes into intimate contact with the insulation member 7. The power feeding members 91 to 93 come into intimate contact with the insulation member 7.

(Description of Power Feeding Members 91 to 93)

The power feeding members 91 to 93 are intended to feed power to the light source portion 10. The power feeding members 91 to 93 are made of electrically conductive metal members, for example. One-end parts (upper end parts) of the power feeding members 91 to 93 are formed in a divergent shape, and are respectively positioned in the cutouts 81 to 83 of the heat radiation member 8 and through holes 31 to 33 of the board 3. One-end parts of the power feeding members 91 to 93 are respectively electrically connected to the wire 6 of the light source 10 via the connecting member 17.

That is, as shown in FIG. 4, on one end face (an upper end face) of the insulation member 7, protrusive portions 72 that are protrusive into the cutouts 81 to 83 are integrally provided at sites corresponding to the cutouts 81 to 83 of the heat radiation member 8. One-end parts of the power feeding members 91, 92, and 93 are protrusive from the protrusive portions 72; are electrically and mechanically connected to the connecting member 17; and are respectively electrically connected to the first conductor 51, the third conductor 53, and the second conductor 52 of the board 3. In this manner, the light source portion 10 is mounted on one end part (a one-end opening portion) of the socket portion 11 that is formed in a cylindrical shape.

The other-end parts (lower end parts) of the power feeding members 91 to 93 are formed in a narrowed shape, and are disposed in the connector portion 13. The other-end parts of the power feeding members 91 to 93 constitute male terminals (male-type terminals) 910, 920, and 930.

(Description of Connector Portion 13 and Connector 14)

As shown in FIG. 11, at the connector 14, female terminals (female-type terminals) 141, 142, and 143 are provided for electrically connecting to or disconnecting from the male terminals 910 to 930 of the connector portion 13. The connector 14 is mounted on the connector portion 13, whereby the female terminals 141 to 143 electrically connect to the male terminals 910 to 930. In addition, the connector 14 is removed from the connector portion 13, whereby electrical connection between the male terminals 141 to 143 and the male terminals 910 to 930 is interrupted.

As shown in FIG. 11, the first female terminal 141 and the second female terminal 142 of the connector 14 are connected to a power source (a direct current power battery) 15 via harnesses 144 and 145 and a switch SW. The third female terminal 143 of the connector 14 is earthed (grounded) via a harness 146. The connector portion 13 and the connector 14 are a connector portion and a connector of three-pin type (the three power feeding members 91 to 93, the three male terminals 910 to 930, and the three female terminals 141 to 143).

(Description of Switch SW)

The switch SW is a three-position changeover switch made of a movable contact point 150, a first fixed contact point 151, a second fixed contact point 152, a third fixed contact point 153, and a common fixed contact point 154.

When the movable contact point 150 is switched to a position of the first fixed contact point 151 (when a state indicated by the single-dotted chain line in FIG. 11 is established), a current (a drive current) is supplied to one light emitting chip 40 having the tail lamp function via the diode D2 having the tail lamp function and the resistors R8 and R9. That is, a drive current is supplied to one light emitting chip 40 having the tail lamp function via the diode D2 having the tail lamp function and the resistors R8 and R9.

When the movable contact point 150 is switched to a position of the second fixed contact point 152 (when a state indicated by the double-dotted chain line in FIG. 11 is established), a current (a drive current) is supplied to the four light emitting chips 41 to 44 having the stop lamp function via the diode D1 having the stop lamp function and the resistors R1 to R7. That is, a drive current is supplied to the light emitting chips 41 to 44 having the stop lamp function via the diode D1 having the stop lamp function and the resistors R1 to R7.

When the movable contact point 150 is switched to a position of the third fixed contact point 153 (when a state indicated by the solid line in FIG. 11 is established), power supply to the five light emitting chips 40 to 44 is interrupted.

(Description of Cover Portion 12)

The cover portion 12 is made of an optically transmissible member. At the cover portion 12, an optical control portion (not shown) such as a prism is provided for optically controlling and emitting light from the five light emitting chips 40 to 44. The cover portion 12 is an optical part or an optical member.

The cover portion 12, as shown in FIG. 2, is mounted on one end part (a one-end opening portion) of the socket portion 11 that is formed in a cylindrical shape so as to cover the light source portion 10. The cover portion 12, together with the sealing member 180, is intended to prevent the five light emitting chips 40 to 44 from an external effect, for example, from being contacted by any other foreign matter or from adhering of dust. That is, the cover portion 12 is intended to protect the five light emitting chips 40 to 44 from a disturbance. In addition to protecting the five light emitting chips 40 to 44, the cover portion 12 is also intended to protect from a disturbance: the resistors R1 to R12 and the diodes D1 and D2, each of which serves as a control element; and the conductors 51 to 57, the wire lines 61 to 65, and the bonding portions 610 to 650, each of which serves as a wiring element. A through hole (not shown) may be provided in the cover portion 12.

(Description of Connecting Member 17)

Hereinafter, the connecting member 17 will be described. The connecting member 17 is comprised of a member having its electrical conductivity, elasticity, and attributes (expandability or plasticity), for example, a member made of a material such as phosphorus bronze or brass. The connecting member 17 is intended to electrically connect the light source portion 10 and the socket portion 11 to each other.

(Description of Electrical Connection Between Light Source Portion and Socket Portion by Means of Connecting Member)

First, two light source connecting portions (not shown) of the connecting member 17 are respectively engaged with two engagement holes (not shown) of the board 3 of the light source portion 10, and a heat is applied to an electrically conductive adhesive agent (not shown) that is provided around the engagement holes of the board 3. In this manner, the light source connecting portions of the connecting member 17 are respectively electrically and mechanically connected to the first conductor 51, the second conductor 52, and the third conductor 53 of the board 3 of the light source portion 10, and the board 3 of the light source portion 10 and the connecting member 17 are temporarily fixed (sub-assembled) to each other.

Next, a thermally conductive medium (not shown) is applied onto the abutment surface 80 of the heat radiation member 8 of the socket portion 11, and one-end parts of the power feeding members 91 to 93 are inserted into the through holes 31 to 33 of the board 3.

Next, the abutment surface 35 of the board 3 of the light source portion 10 is placed on the thermally conductive medium of the socket portion 11. Then, two socket connecting portions (not shown) of the connecting member 17 are securely tightened at both sides of one-end parts of the power feeding members 91 to 93. In addition, the securely tightened two socket connecting portions of the connecting member 17 and both sides of the one-end parts of the power feeding members 91 to 93 are welded by means of laser welding or the like. In this manner, the socket connecting portions of the connecting member 17 are electrically and mechanically connected to the power feeding members 91 to 93 of the socket portion 11.

In the foregoing securely tightening process and in the foregoing welding process, the board 3 is pressurized to the side of the heat radiation member 8. Under the foregoing pressurization, the thermally conductive medium is mounted and fixed. In this manner, the light source portion 10 and the socket portion 11 are electrically connected to each other by means of the connecting member 17.

(Description of Functions)

A light source unit 1 of a semiconductor-type light source of a vehicle lighting device, in the exemplary embodiment, and a vehicle lighting device 100 in the exemplary embodiment (hereinafter, referred to as the light source unit 1 and the vehicle lighting device 100, in the exemplary embodiment) are made of the constituent elements described above. Hereinafter, functions of the light source unit and the vehicle lighting device will be described.

First, a movable contact point 150 of a switch SW is switched to a first fixed contact point 151. Then, a current (a drive current) is supplied to one light emitting chip 40 of a tail lamp function via a diode D2 of a tail lamp function and resistors R8 and R9. As a result, one light emitting chip 40 having the tail lamp function emits light.

The light that is radiated from one light emitting chip 40 having the tail lamp function passes through a sealing member of the light source unit 1 and a cover portion 12, and is controlled to be optically distributed. A part of the light that is radiated from the light emitting chip 40 is reflected on the side of the cover portion 12 by means of a high reflection surface of a board 3. The light that is controlled to be optically distributed passes through a lamp lens 102 of the vehicle lighting device 100; is controlled to be optically distributed again; and then, is emitted to the outside. In this manner, the vehicle lighting device 100 emits light distribution having the tail lamp function to the outside.

Next, the movable contact point 150 of the switch SW is switched to a second fixed contact point 152. Then, a current (a drive current) is supplied to four light emitting chips 41 to 44 of a stop lamp function via a diode D1 having the stop lamp function and resistors R1 to R7. As a result, the four light emitting chips 41 to 44 of the stop lamp emit light.

The light that is radiated from the four light emitting chips 41 to 44 having the stop lamp function passes through the sealing member of the light source unit 1 and the cover member 12, and is controlled to be optically distributed. A part of the light that is radiated from the light emitting chips 41 to 44 is reflected on the side of the cover portion 12 by means of the high reflection surface of the board 3. The light that is controlled to be optically distributed passes through the lamp lens 102 of the vehicle lighting device 100; is controlled to be optically distributed again; and then, is emitted to the outside. In this manner, the vehicle lighting device 100 emits light distribution having the stop lamp function to the outside. The light distribution having the stop lamp function is bright (large in luminous flux, luminance, luminous intensity, or intensity of illumination) in comparison with that of the tail lamp.

Next, the movable contact point 150 of the switch SW is switched to a third fixed contact point 153. Then, a current (a drive current) is interrupted. As a result, one light emitting chip 40 or the four light emitting chips 41 to 44 turns or turn off the light. In this manner, the vehicle lighting device 100 turns off the light.

Then, the heat that is generated in the light emitting chips 40 to 44 of the light source portion 10; the resistors R1 to R10; the diodes D1 and D2; and the conductors 51 to 56 transfers to the heat radiation member 8 via the board 3 and the thermally conductive medium, and then, the heat that is transferred thereto is radiated from the heat radiation member 8 to the outside. In addition, if at least one of the four light emitting chips 41 to 44 having the stop lamp function is disconnected in wiring, a system on the vehicle side can detect wire disconnection of at least one of the four light emitting chips 41 to 44 having the stop lamp function, due to a state change of pull-down resistors R11 and R12.

(Description of Advantageous Effects)

The light source unit 1 and the vehicle lighting device 100, in the exemplary embodiment, is made of the constituent elements and functions as described above. Hereinafter, advantageous effects of the light source unit and the vehicle lighting device will be described.

The light source unit 1 and the vehicle lighting device 100, in the exemplary embodiment, as shown in FIG. 1 and FIG. 2, are provided in such a manner that: a light emitting chip 40 of a tail lamp function in a first group is sandwiched between light emitting chips 41, 42 and 43, 44 of a stop lamp function in a second group; a first conductor 51 for feeding power to the light emitting chip 40 having the tail lamp function is mounted on a lower mounting face 34 of the mounting surface 34 of a board 3 that is divided into two upper and lower sides by means of a line segment L connecting the light emitting chips 41, 42 and 43, 44 having the stop lamp function that sandwich the light emitting chip 40 having the tail lamp function. As a result, the light source unit 1 and the vehicle lighting device 100, in the exemplary embodiment, do not need to provide a wiring element for feeding power to the light emitting chips 41, 42, 43, and 44 having the stop lamp function, the wiring element being capable of mutually approaching the neighboring fourth conductor 54 and fifth conductor 55 (refer to FIG. 1 and FIG. 2), the wiring element being configured to electrically interconnect the adjacent fourth conductor 54 and fifth conductor 55, i.e., a third wire line 63, so as to be bridged over the first conductor 51 for feeding the light emitting chip 40 having the tail lamp function (refer to FIG. 3) to thus able to eliminate a failure that the third wire line 63 for feeding power to the light emitting chips 41, 42, 43, and 44 having the stop lamp function comes into contact the first conductor 51 for feeding power to the light emitting chip 40 having the tail lamp function and then is shorted (short-circuited). In this manner, the light source unit 1 and the vehicle lighting device 100 according to the exemplary embodiment are capable of reliably wire the wiring elements for feeding power to light emitting chips so as not to be shorted.

Moreover, the light source unit 1 of the semiconductor-type light source of the vehicle lighting device 100, in the exemplary embodiment, are provided in such a manner that: the third wiring element 63 for feeding power to the light emitting chips 41, 42, 43, and 44 having the stop lamp function (the third wire line 63 configured to electrically interconnect the neighboring fourth conductor 54 and fifth conductor 55) can be reduced in length to able to reduce failures caused by its large length, i.e., failures such as cutting of the third wiring element 63 or removing a bonding portion 630 of the third wiring line 63. That is, the light source unit 1 of the semiconductor-type light source of the vehicle lighting device 100, in the exemplary embodiment, is capable of reducing the length of the third wire line 63 to thus able to reduce a wire disconnection stress (a wire disconnection load) of the third wire line 63 or able to reduce a stress (a load) of the bonding portion 630 of the third wire line 63. In this manner, the light source unit 1 of the semiconductor-type light source of the vehicle lighting device 100, in the exemplary embodiment, is capable of reliably providing the wiring elements for feeding power to the light emitting chips.

Still moreover, the light source unit 1 and the vehicle lighting device 100, in the exemplary embodiment, are provided in such a manner that a conductor for feeding power to the light emitting chips 41, 42, 43, and 44 having the stop lamp function, the conductor being capable of mutually approaching the neighboring fourth conductor 54 and fifth conductor 55, can thus increase an area of the neighboring fourth conductor 54 and fifth conductor 55, and can thus effectively radiate the heat that is generated in the neighboring fourth conductor 54 and fifth conductor 55 to an external heat radiation member 8 via the board 3 and a thermally conductive medium. That is, a heat radiation effect is improved.

In addition, the light source unit 1 and the vehicle lighting device 100, in the exemplary embodiment, are provided in such a manner that: the five light emitting chips 40 to 44 are disposed at a center part of a mounting surface 34 of the board 3; the resistors R1 to R12 and the diodes D1 and D2, each of which serves as a control element, are disposed at a peripheral portion of the mounting surface 34 of the board 3 (that is, outside of the five light emitting chips 40 to 44) to thereby able to broaden an area of the conductors 51 to 56 for feeding power to the five light emitting chips 40 to 44. As a result, the light source unit 1 and the vehicle lighting device 100, in the exemplary embodiment, can effectively radiate the heat that is generated in the conductors 51 to 56 for feeding powder to the four light emitting chips 40 to 44, to the external heat radiation member 8 via the board 3 and the thermally conductive medium. That is, a heat radiation effect is improved.

Further, the light source unit 1 and the vehicle lighting device 100, in the exemplary embodiment, are provided in such a manner that: pull-down resistors R11 and R12 for detecting a wire disconnection of at least one of the four light emitting chips 41, 42, 43, and 44 having the stop lamp function are disposed at a rear stage (a cathode side) of the first diode D1 as a control element for controlling light emission of the light emitting chips 41, 42, 43, and 44 having the stop lamp function, whereby in the pull-down resistors R11 and R12, an inversion polar surge can be eliminated at the diode D1 at a front stage, so that a capacitive durability quantity considering only a forward directional surge will suffice. As a result, the light emitting unit 1 and the vehicle lighting device 100, in the exemplary embodiment, can downsize the pull-down resistors R11 and R12 to thus able to increase an area of the conductors 53 to 56, each of which serves as a wiring element for supplying a mass current to the light emitting chips 41, 42, 43, and 44 having the stop lamp function. In this manner, the light emitting unit 1 and the vehicle lighting device 100, in the exemplary embodiment, can effectively radiate the heat that is generated in the conductors 53 to 56, each of which serves as a wiring element for supplying a mass current to the light emitting chips 41, 42, 43, and 44 having the stop lamp function, to the external heat radiation member 8 via the board 3 and the thermally conductive medium. That is, a heat radiation effect is improved.

Furthermore, the light emitting unit 1 and the vehicle lighting device 100, in the exemplary embodiment, is provided in such a manner that: when the light source unit 1 is mounted on the vehicle lighting device 100, the resistors R1 to R7, each of which serves as a control element for controlling light emission of the light emitting chips 41, 42, 43, and 44 to which a mass current is to be supplied, are positioned in a location that is upper than that of the five light emitting chips 40 to 44, so that the heat that generated in the resistors R1 to R7 is released upward without having an effect on the five light emitting chips 40 to 44. That is, durability and performance or the like of the five light emitting chips 40 to 44 can be improved by utilizing a property of upward heat releasing.

(Description of Modification Example of Wire Line)

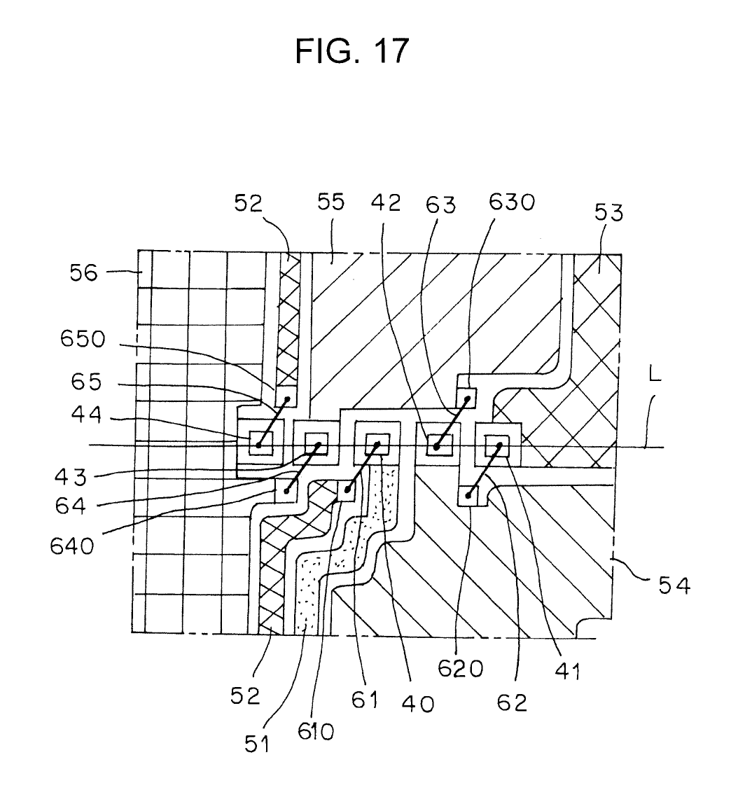

FIG. 17 is an explanatory view showing a modification example of wire lines. In the figure, like constituent elements are designated by like reference numerals shown in FIG. 1 to FIG. 16. This modification example of wire lines shows that a plurality of, in this example, five wire lines 61 to 65 that are respectively electrically connected to a plurality of, in this example, five light emitting chips 40 to 44 are provided in parallel to each other or in substantially parallel to each other. In this way, the five wire lines 61 to 65 that are respectively electrically connected to the five light emitting chips 40 to 44 are provided in parallel to each other or in substantially parallel to each other, whereby wiring workability of the five wire lines 61 to 65 is improved, a production speed increases, and manufacturing costs can be reduced. Moreover, the five wire lines 61 to 65 are coincident with each other in a unidirectional manner or in a substantially unidirectional manner, so that electrical reliability of the five wire lines 61 to 65 are improved.

(Description of Modification Example of Disposition of a Plurality of Light Emitting Chips)

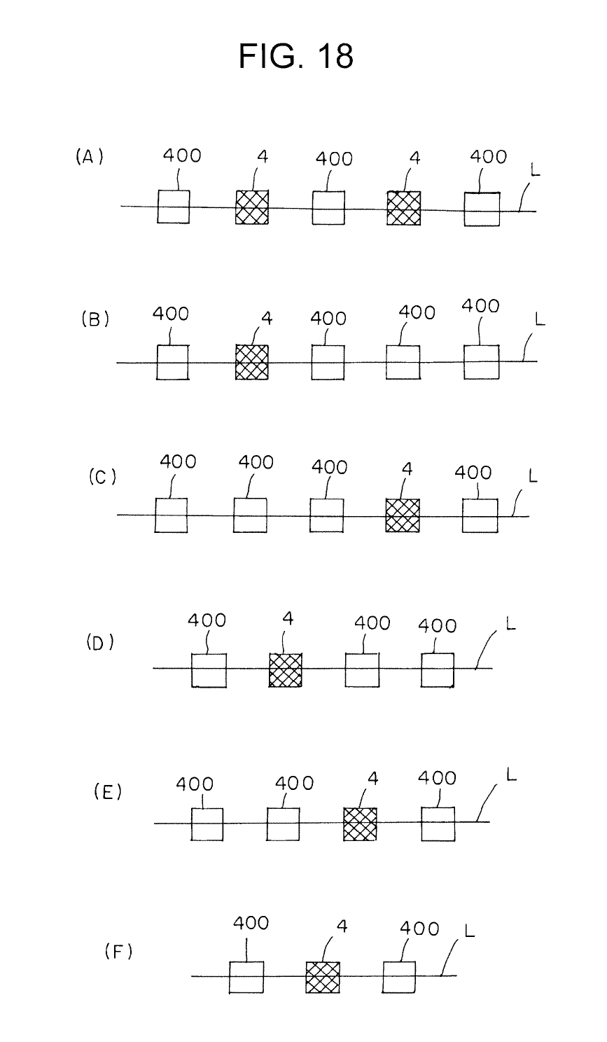

FIG. 18 (A) to FIG. 18 (F) are explanatory views, each of which shows an example of disposition of a plurality of light emitting chips. FIG. 18 (A) shows that there are provided: two light emitting chips 4 of a tail lamp function (chips to which the oblique lattice is applied); and three light emitting chips 400 of a stop lamp function (outlined chips). Among these light emitting chips 4, a light emitting chip 4 having the tail lamp function at the left side is sandwiched between the light emitting chip 400 having the stop lamp function at the left side and the light emitting chip 400 of the stop lamp at the center, and a light emitting chip 4 having the tail lamp function at the right side is sandwiched between the light emitting chip 400 having the stop lamp function at the right side and the light emitting chip 400 of the stop lamp at the center. Conductors for feeding power to the light emitting chips 4 having the tail lamp function are mounted on either one relative to a segment line L. Among these conductors, for example, a conductor for feeding power to the light emitting chip 4 having the tail lamp function at the left side; and a conductor for feeding power to the light emitting chip 4 having the tail lamp function at the right side, are respectively mounted at an upper side relative to the line segment L, or alternatively, a conductor for feeding power to the light emitting chip 4 having the tail lamp function at the left side; and a conductor for feeding power to the light emitting chip 4 having the tail lamp function at the right side, are respectively mounted on a lower side relative to the line segment L. Alternatively, the conductor for feeding power to the light emitting chip 4 having the tail lamp function at the left side is mounted on the upper side relative to the line segment L, and the conductor for feeding power to the light emitting chip 4 having the tail lamp function at the right side is mounted on the lower side relative to the line segment L, respectively. Alternatively, the conductor for feeding power to the light emitting chip 4 having the tail lamp function at the left side is mounted on the lower side relative to the line segment L, and the conductor for feeding power to the light emitting chip 4 having the tail lamp function at the right side is mounted on the upper side relative to the line segment L, respectively. The light emitting chip 400 of the stop lamp at the center may be employed as a light emitting chip 4 of a tail lamp function. In this case, three light emitting chips 4 having the tail lamp function are sandwiched between the light emitting chips 400 having the stop lamp function at the left and right sides.

FIG. 18 (B) shows that there are provided: one light emitting chip 4 of a tail lamp function (the chip to which oblique lattice is applied); and four light emitting chips 400 (outlined chips) of a stop lamp function. One light emitting chip 4 having the tail lamp function is sandwiched between one light emitting chip 400 at the left side and three light emitting chips 400 of a stop lamp function at the right side. A conductor for feeding power to the light emitting chip 4 having the tail lamp function is mounted on either one side (an upper side or a lower side) relative to the line segment L. The light emitting chip 400 having the stop lamp function at the center may be employed as a light emitting chip 4 of a tail lamp function.

FIG. 18 (C) shows that there are provided: one light emitting chip 4 of a tail lamp function (the chip to which oblique lattice is applied); and four light emitting chips 400 (outlined chips) of a stop lamp function. One light emitting chip 4 having the tail lamp function is sandwiched between one light emitting chip 400 at the left side and three light emitting chips 400 of a stop lamp function at the right side. A conductor for feeding power to the light emitting chip 4 having the tail lamp function is mounted on either one side (an upper side or a lower side) relative to the line segment L. The light emitting chip 400 having the stop lamp function at the center may be employed as a light emitting chip 4 of a tail lamp function.

FIG. 18 (D) shows that there are provided: one light emitting chip 4 of a tail lamp function (the chip to which oblique lattice is applied); and three light emitting chips 400 (outlined chips) of a stop lamp function. One light emitting chip 4 having the tail lamp function is sandwiched between one light emitting chip 400 at the left side and two light emitting chips 400 of a stop lamp function at the right side. A conductor for feeding power to the light emitting chip 4 having the tail lamp function is mounted on either one side (an upper side or a lower side) relative to the line segment L. The light emitting chip 400 having the stop lamp function in the right neighborhood of the light emitting chip 4 having the tail lamp function may be employed as a light emitting chip 4 of a tail lamp function.

FIG. 18 (E) shows that there are provided: one light emitting chip 4 of a tail lamp function (the chip to which oblique lattice is applied); and three light emitting chips 400 (outlined chips) of a stop lamp function. One light emitting chip 4 having the tail lamp function is sandwiched between one light emitting chip 400 at the left side and two light emitting chips 400 of a stop lamp function at the right side. A conductor for feeding power to the light emitting chip 4 having the tail lamp function is mounted on either one side (an upper side or a lower side) relative to the line segment L. The light emitting chip 400 having the stop lamp function in the left neighborhood of the light emitting chip 4 having the tail lamp function may be employed as a light emitting chip 4 of a tail lamp function.

FIG. 18 (F) shows that there are provided: one light emitting chip 4 of a tail lamp function (the chip to which oblique lattice is applied); and two light emitting chips 400 (outlined chips) of a stop lamp function. One light emitting chip 4 having the tail lamp function is sandwiched between one light emitting chip 400 at the left side and one light emitting chips 400 of a stop lamp function at the right side. A conductor for feeding power to the light emitting chip 4 having the tail lamp function is mounted on either one side (an upper side or a lower side) relative to the line segment L.

(Description of Examples Other than Exemplary Embodiment)

In the foregoing exemplary embodiment, five light emitting chips 40 to 44 are used. However, in the present invention, two to four light emitting chips or six or more light emitting chips may be used. The number or layout of light emitting chips used as a tail lamp function and the number or layout of light emitting chips used as a stop lamp function are not limited in particular.

In addition, in the foregoing exemplary embodiment, a tail/stop lamp is used. However, in the present invention, a combination lamp other than the tail/stop lamp or a lamp of a single function can be used. The lamps of the single function includes: a turn signal lamp; a backup lamp; a stop lamp; a tail lamp; a low beam head lamp (a head lamp for passing); a high beam head lamp (a head lamp for cruising); a fog lamp; a clearance lamp; a cornering lamp; a daytime running lamp or the like. That is, a light source unit made of a light emitting chip to which a low current is supplied and of which light emission quantity is small and a light emitting chip to which a mass current is supplied and of which light emission quantity is large functions in the same way as a light source unit of double filaments made of a subsidiary filament of which light emitting quantity is the smallest and a main filament of which light emission quantity is large.

Further, in the foregoing exemplary embodiment, switching of two lamps between a tail lamp and a stop lamp is available. However, in the present invention, switching of three or more lamps is also available.

Furthermore, in the foregoing exemplary embodiment, five light emitting chips 40 to 44 are disposed in one line. However, in the present invention, light emitting chips may be disposed in a circular shape on a corner of a rectangle. For example, the light emitting chips may be disposed at four corners of a square or at three corners of a triangle.

Still furthermore, in the foregoing exemplary embodiment, light distribution is controlled by means of a cover portion 12 and a lamp lens 102. However, in the present invention, light distribution may be controlled by means of at least one of the cover portion 12 and the lamp lens 102, or alternatively, by means of any other constituent element such as a reflection surface or a lens.

Yet furthermore, in the foregoing exemplary embodiment, a connector portion 13 is integrally provided at a socket portion 11. However, in the present invention, the connector portion 13 may not be integrally provided at the socket portion 11. In this case, a connector on a light source side is provided independently of the socket portion 11, and the connector on the light source side is electrically connected to a power feeding member (refer to power feeding members 91 to 93 of the exemplary embodiment) of a light source unit 1 via a harness. A connector 14 on a power source is mounted on the connector on the light source side, whereby electric power is supplied to a light source portion 10, and the connector 14 on the power source side is removed from the connector on the light source side, whereby electric power supply to the light source portion 10 is interrupted.

Moreover, in the foregoing exemplary embodiment, a first conductor 51 for feeding power a light emitting chip 40 of a tail lamp function is mounted on a lower mounting surface 34 of mounting surface 34 of a board 3 that is divided into two upper and lower sides by means of a line segment L connecting light emitting chips 41, 42 and 43, 44 of a stop lamp function. However, in the present invention, the first conductor 51 may be mounted on an upper mounting surface 34 of the mounting surface 34 of the board 3 that is divided into two upper and lower sides by means of the line segment L. In addition, in a case where light emitting chips are arranged in a longitudinal direction, these chips may be mounted on a left side mounting surface or on a right side mounting surface that is divided into two left and right sides. Further, in a case where light emitting chips are arranged in an oblique direction, these chips may be mounted on one mounting surface or the other mounting surface of a board that is obliquely divided into two sections.

Still moreover, in the foregoing exemplary embodiment, light emitting chips 40 to 44; conductors 51 to 57, a wiring element, wire lines 61 to 65, and bonding portions 610 to 650, each of which serves as a wiring element; resistors R1 to R12; and diodes D1 and D2 are mounted on a mounting surface 34 of a board 3 that serves as a mount member. However, in the present invention, without using the board 3, the light emitting chips 40 to 44, the conductors 51 to 57, each of which serves as a wiring element; the wire lines 61 to 65; the bonding portions 610 to 650; the resistors R1 to R12; and the diodes D1 and D2 may be mounted on a mounting surface (an abutment surface 80) of a heat radiation member 8 via an insulation layer. In this case, the heat radiation member 8 is employed as a mount member.

Yet moreover, in the foregoing embodiment, a socket portion 11 having an insulation member 7, a radiation member 8, and three power feeding member 91, 92, and 93 are used as a light source unit 1. However, in the present invention, only the heat radiation member 8 may be used as a light source unit without using the insulation member 7 and the three power feeding members 91, 92, and 93. In this case, the light source unit is provided with: a heat radiation member; a board or an insulation layer that serves as an insulation member; and a light source portion. On the other hand, a vehicle lighting device is provided with a power feeding member to be electrically connected to a power feeding electrode (not shown) of a light source portion.

What is claimed is:

1. A light source unit of a semiconductor-type light source of a vehicle lighting device, comprising:
a mount member;
a plurality of light emitting chips of semiconductor-type light sources that are intensively mounted on the mount member;
a control element that is mounted on the mount member, for controlling light emission of the light emitting chips; and
wiring elements that are mounted on the mount member, for feeding power to the light emitting chips via the control element,
wherein the plurality of the light emitting chips are divided into two groups,
the light emitting chips in a first group are sandwiched between the light emitting chips in a second group, and
among the wiring elements, a wiring element for feeding power to the light emitting chip in the first light emitting chips is mounted on either one side of mounting surface of the mount member that is divided into two sections by means of a line segment connecting the light emitting chips in the second group configured to sandwich the light emitting chips in the first group.

2. The light source unit of the semiconductor-type light source of the vehicle lighting device, according to claim 1,
wherein the plurality of the light emitting chips are disposed at a center part of the mounting surface of the mount member, and
the control element is disposed at a peripheral portion of the mounting surface of the mount member.

3. The light source unit of the semiconductor-type light source of the vehicle lighting device, according to claim 1,
wherein the light emitting chips in the first group are light emitting chips to which a low current is to be supplied,
the light emitting chips in the second group are light emitting chips to which a mass current is to be supplied,
the control element for controlling light emission of the light emitting chips in the second group comprises at least a diode, and
a pull-down resistor for detecting a wire disconnection of the light emitting chips in the second group is disposed at a rear stage of the diode.

4. The light source unit of the semiconductor-type light source of the vehicle lighting device, according to claim 1,
wherein the light emitting chips in the first group are light emitting chips to which a low current is to be supplied,
the light emitting chips in the second group are light emitting chips to which a mass current is to be supplied,
the control element for controlling light emission of the light emitting chips in the second group comprises at least a resistor, and
the resistor is disposed so as to be positioned in a location that is upper than a position of the plurality of the light emitting chips when the light source unit is mounted on the vehicle lighting device.

5. The light source unit of the semiconductor-type light source of the vehicle lighting device, according to claim 1,
wherein a part of the wiring elements is comprised of wire lines that are respectively electrically connected to the plurality of the light emitting chips, and
the plurality of the wire lines are provided in parallel to each other or in substantially parallel to each other.

6. A vehicle lighting device using a semiconductor-type light source as a light source, comprising:
a lamp housing and a lamp lens that partition a lamp room; and
a light source unit of a semiconductor-type light source of the vehicle lighting device according to claim 1 that is disposed in the lamp room.
